(19) United States
(12) Patent Application Publication
(10) Pub. No.: US 2022/0319205 A1
(43) Pub. Date: Oct. 6, 2022

(54) SYSTEM AND METHOD FOR OBJECT RECOGNITION USING THREE DIMENSIONAL MAPPING TOOLS IN A COMPUTER VISION APPLICATION

(71) Applicant: BASF Coatings GmbH, Münster (DE)

(72) Inventors: Yunus Emre Kurtoglu, Southfield, MI (US); Matthew lan Childers, Southfield, MI (US)

(21) Appl. No.: 17/616,469

(22) PCT Filed: Jun. 5, 2020
(86) PCT No.: PCT/EP2020/065748

§ 371 Date: Dec. 3, 2021

Related U.S. Application Data
(60) Provisional application No. 62/858,355, filed on Jun. 7, 2019.

(30) Foreign Application Priority Data
Jun. 7, 2019 (EP) 19179172.2

(51) Int. Cl. G06V 20/64; G06V 10/60; G06V 10/145

(52) U.S. Cl. CPC G06V 20/653; G06V 10/60; G06V 10/145

(57) ABSTRACT

Described herein are a system and a method for object recognition via a computer vision application, the system including at least the following components:
an object to be recognized, the object having object specific reflectance and luminescence spectral patterns,
a light source which is configured to project at least one light pattern on a scene which includes the object to be recognized,
a sensor which is configured to measure radiance data of the scene including the object when the scene is illuminated by the light source,
a data storage unit which includes luminescence spectral patterns together with appropriately assigned respective objects, and
a data processing unit.

The present disclosure refers to a system and a method for object recognition via a computer vision application using three dimensional mapping tools.

### BACKGROUND

Computer vision is a field in rapid development due to abundant use of electronic devices capable of collecting information about their surroundings via sensors such as cameras, distance sensors such as LiDAR or radar, and depth camera systems based on structured light or stereo vision to name a few. These electronic devices provide raw image data to be processed by a computer processing unit and consequently develop an understanding of an environment or a scene using artificial intelligence and/or computer assistance algorithms. There are multiple ways how this understanding of the environment can be developed. In general, 2D or 3D images and/or maps are formed, and these images and/or maps are analyzed for developing an understanding of the scene and the objects in that scene. One prospect for improving computer vision is to measure the components of the chemical makeup of objects in the scene. While shape and appearance of objects in the environment acquired as 2D or 3D images can be used to develop an understanding of the environment, these techniques have some shortcomings.

One challenge in computer vision field is being able to identify as many objects as possible within each scene with high accuracy and low latency using a minimum amount of resources in sensors, computing capacity, light probe etc. The object identification process has been termed remote sensing, object identification, classification, authentication or recognition over the years. In the scope of the present disclosure, the capability of a computer vision system to identify an object in a scene is termed as “object recognition”. For example, a computer analyzing a picture and identifying/labelling a ball in that picture, sometimes with even further information such as the type of a ball (basketball, soccer ball, baseball), brand, the context, etc. fall under the term “object recognition”.

Generally, techniques utilized for recognition of an object in computer vision systems can be classified as follows:

Technique 1: Physical tags (image based): Barcodes, QR codes, serial numbers, text, patterns, holograms etc.

Technique 2: Physical tags (scan/close contact based): Viewing angle dependent pigments, upconversion pigments, metachromics, colors (red/green), luminescent materials.

Technique 3: Electronic tags (passive): RFID tags, etc. Devices attached to objects of interest without power, not necessarily visible but can operate at other frequencies (radio for example).

Technique 4: Electronic tags (active): wireless communications, light, radio, vehicle to vehicle, vehicle to anything (X), etc. Powered devices on objects of interest that emit information in various forms.

Technique 5: Feature detection (image based): Image analysis and identification, i.e. two wheels at certain distance for a car from side view; two eyes, a nose and mouth (in that order) for face recognition etc. This relies on known geometries/shapes.

Technique 6: Deep learning/CNN based (image based): Training of a computer with many of pictures of labeled images of cars, faces etc. and the computer determining the features to detect and predicting if the objects of interest are present in new areas. Repeating of the training procedure for each class of object to be identified is required.

Technique 7: Object tracking methods: Organizing items in a scene in a particular order and labeling the ordered objects at the beginning. Thereafter following the object in the scene with known color/geometry/3D coordinates. If the object leaves the scene and re-enters, the “recognition” is lost.

In the following, some shortcomings of the above-mentioned techniques are presented.

Technique 1: When an object in the image is occluded or only a small portion of the object is in the view, the barcodes, logos etc. may not be readable. Furthermore, the barcodes etc. on flexible items may be distorted, limiting visibility. All sides of an object would have to carry large barcodes to be visible from a distance otherwise the object can only be recognized in close range and with the right orientation only. This could be a problem for example when a barcode on an object on the shelf at a store is to be scanned. When operating over a whole scene, technique 1 relies on ambient lighting that may vary.

Technique 2: Upconversion pigments have limitations in viewing distances because of the low level of emitted light due to their small quantum yields. They require strong light probes. They are usually opaque and large particles limiting options for coatings. Further complicating their use is the fact that compared to fluorescence and light reflection, the upconversion response is slower. While some applications take advantage of this unique response time depending on the compound used, this is only possible when the time of flight distance for that sensor/object system is known in advance. This is rarely the case in computer vision applications. For these reasons, anti-counterfeiting sensors have covered/dark sections for reading, class 1 or 2 lasers as probes and a fixed and limited distance to the object of interest for accuracy.

Similarly viewing angle dependent pigment systems only work in close range and require viewing at multiple angles. Also, the color is not uniform for visually pleasant effects. The spectrum of incident light must be managed to get correct measurements. Within a single image/scene, an object that has angle dependent color coating will have multiple colors visible to the camera along the sample dimensions.

Color-based recognitions are difficult because the measured color depends partly on the ambient lighting conditions. Therefore, there is a need for reference samples and/or controlled lighting conditions for each scene. Different sensors will also have different capabilities to distinguish different colors, and will differ from one sensor type/maker to another, necessitating calibration files for each sensor.

Luminescence based recognition under ambient lighting is a challenging task, as the reflective and luminescent components of the object are added together. Typically luminescence based recognition will instead utilize a dark measurement condition and a priori knowledge of the excitation region of the luminescent material so the correct light probe/source can be used.

Technique 3: Electronic tags such as RFID tags require the attachment of a circuit, power collector, and antenna to the item/object of interest, adding cost and complication to the design. RFID tags provide present or not type information but not precise location information unless many sensors over the scene are used.

Technique 4: These active methods require the object of interest to be connected to a power source, which is cost-prohibitive for simple items like a soccer ball, a shirt, or a box of pasta and are therefore not practical.

Technique 5: The prediction accuracy depends largely on the quality of the image and the position of the camera within the scene, as occlusions, different viewing angles, and the like can easily change the results. Logo type images can be present in multiple places within the scene (i.e., a logo can be on a ball, a T-shirt, a hat, or a coffee mug) and the object recognition is by inference. The visual parameters of the object must be converted to mathematical parameters at great effort. Flexible objects that can change their shape are problematic as each possible shape must be included in the database. There is always inherent ambiguity as similarly shaped objects may be misidentified as the object of interest.

Technique 6: The quality of the training data set determines the success of the method. For each object to be recognized/classified many training images are needed. The same occlusion and flexible object shape limitations as for Technique 5 apply. There is a need to train each class of material with thousands or more of images.

Technique 7: This technique works when the scene is pre-organized, but this is rarely practical. If the object of interest leaves the scene or is completely occluded the object could not be recognized unless combined with other techniques above.

Apart from the above-mentioned shortcomings of the already existing techniques, there are some other challenges worth mentioning. The ability to see a long distance, the ability to see small objects or the ability to see objects with enough detail all require high resolution imaging systems, i.e. high-resolution camera, LiDAR, radar etc. The high-resolution needs increase the associated sensor costs and increase the amount of data to be processed.

For applications that require instant responses like autonomous driving or security, the latency is another important aspect. The amount of data that needs to be processed determines if edge or cloud computing is appropriate for the application, the latter being only possible if data loads are small. When edge computing is used with heavy processing, the devices operating the systems get bulkier and limit ease of use and therefore implementation.

Thus, a need exists for systems and methods that are suitable for improving object recognition capabilities for computer vision applications.

### SUMMARY OF THE INVENTION

One emerging field of commercial significance is 3D mapping of indoor and outdoor environments for various computer vision applications such as artificial intelligence, autonomous systems, augmented reality to name a few. Some of the mapping techniques that are relevant for the ongoing discussion involve light probes that are either pulsed into a scene (temporal), partially emitted into the scene (structured light) or a combination of the two (dot matrix projector, LiDAR, etc.). Structured light systems often use a deviation from a known geometry of the light introduced to the scene upon the return of the signal back to the camera/sensor and use the distortions to calculate distance/shape of objects. Wavelength of light used in such systems can be anywhere in UV, visible or near-IR regions of the spectrum. In dot projector type systems, a light probe is pulsed into the scene and the time of flight measurements are performed to calculate the target object shape and distance. In some versions, the light probe introduces multiple areas into the field of view of the projector/sensor while in others only a single area is illuminated at a time and the procedure is repeated to scan different areas of the scene over time. In both systems the ambient light that already exists in the scene is discriminated from the light that is introduced to perform the mapping task. These systems strictly rely on the reflective properties of the objects the probes illuminate and read at the spectral bands the light probes operate. Both types of systems are designed to accommodate the sizes and dimensions of interest to the computer vision system and hence the resolution of the areas illuminated by the probe have similar length scales as the objects of interest to be measured, mapped or regognized.

The present disclosure provides a system and a method with the features of the independent claims. Embodiments are subject of the dependent claims and the description and drawings.

According to claim 1, a system for object recognition via a computer vision application is provided, the system comprising at least the following components:
an object to be recognized, the object having an object specific reflectance spectral pattern and an object specific luminescence spectral pattern,
a light source which is configured to project at least one light pattern on a scene which includes the object to be recognized,
a sensor which is configured to measure radiance data of the scene when the scene is illuminated by the light source,
a data storage unit which comprises luminescence spectral patterns together with appropriately assigned respective objects,
a data processing unit which is configured to
   detect/extract the object specific luminescence spectral pattern of the object to be recognized out of the radiance data of the scene and to match the detected/extracted object specific luminescence spectral pattern with the luminescence spectral patterns stored in the data storage unit, and to identify a best matching luminescence spectral pattern and, thus, its assigned object, and
   calculate a distance, a shape, a depth and/or surface information of the identified object in the scene by reflectance characteristics measured by the sensor.

The reflectance characteristics may include temporal elements, such as the amount of time it takes for reflected light (forming part of the object specific reflectance pattern) to return to the sensor, or spatial measurements, such as the measured distortion of the emitted spatial light pattern, i.e. by the way the light pattern deforms when striking a surface of the object.

The reflectance characteristics are to be considered in view of the known object specific reflectance pattern.

The light source may be configured to project a first light pattern on the scene, and then based on the results of the sensor choose a second light pattern, project it on the scene, use those results to project another third light pattern, etc. Thus, the light source can project multiple light patterns one after the other on the scene. Alternatively, the light source can project multiple light patterns simultaneously on the scene. It is also possible that the light source projects a first group of different light patterns at a first point in time on the scene, and then chooses a second group of different light patterns and projects it on the scene at a second point in time. It is also possible to use multiple light sources which can be operated simultaneously or successively, each light source being configured to project one predefined light pattern or a group of light patterns or a series of successive light patterns on the scene. The one light source or each of the multiple light sources can be controlled by a controller, i.e. a control unit. There can be one central controller which can control all light sources of the multiple light sources and, thus, can clearly define an operation sequence of the multiple light sources.

The light source(s), the control unit(s), the sensor, the data processing unit and the data storage unit may be in communicative connection with each other, i. e. networked among each other.

Within the scope of the present disclosure the terms “fluorescent” and “luminescent” “are used synonymously. The same applies to the terms fluorescence” and “luminescence”. Within the scope of the present disclosure the database may be part of the data storage unit or may represent the data storage unit itself. The terms “database” and “data storage unit” are used synonymously. The terms “data processing unit” and “processor” are used synonymously and are to be interpreted broadly.

According to an embodiment of the proposed system, the light pattern or at least one of the light patterns which can be projected by the light source on the scene is chosen from the group consisting of a temporal light pattern, a spatial light pattern and a temporal and spatial light pattern.

In the case that the light source is configured to project a spatial light pattern or a temporal and spatial light pattern on the scene, the spatial part of the light pattern is formed as a grid, an arrangement of horizontal, vertical and/or diagonal bars, an array of dots or a combination thereof.

In the case that the light source is configured to project a temporal light pattern or a temporal and spatial light pattern on the scene, the light source comprises at least one pulsed light source which is configured to emit light in single pulses thus providing the temporal part of the light pattern.

According to a further embodiment of the proposed system, the light source is chosen as one of a dot matrix projector and a time of flight (light) sensor that may emit light on one or more areas/sections of the scene at a time or mutliple areas/sections simultanously. The time of flight sensor may use structured light. Specifically, the light sensor may be a LiDAR.

In still a further embodiment of the system, the sensor is a hyperspectral camera or a multispectral camera.

The sensor is generally an optical sensor with photon counting capabilities. More specifically, it may be a monochrome camera, or an RGB camera, or a multispectral camera, or a hyperspectral camera. The sensor may be a combination of any of the above, or the combination of any of the above with a tuneable or selectable filter set, such as, for example, a monochrome sensor with specific filters. The sensor may measure a single pixel of the scene, or measure many pixels at once. The optical sensor may be configured to count photons in a specific range of spectrum, particularly in more than three bands. It may be a camera with multiple pixels for a large field of view, particularly simultaneously reading all bands or different bands at different times.

A multispectral camera captures image data within specific wavelength ranges across the electromagnetic spectrum. The wavelengths may be separated by filters or by the use of instruments that are sensitive to particular wavelengths, including light from frequencies beyond the visible light range, i.e. infrared and ultra-violet. Spectral imaging can allow extraction of additional information the human eye fails to capture with its receptors for red, green and blue. A multispectral camera measures light in a small number (typically 3 to 15) of spectral bands. A hyperspectral camera is a special case of spectral camera where often hundreds of contiguous spectral bands are available.

In a further embodiment of the system the light source is configured to emit one or more spectral bands within UV, visible and/or infrared light simultaneously or at different times in the light pattern.

The object to be recognized may be provided with a predefined luminescence material and the resulting object's luminescence spectral pattern is known and used as a tag. The object may be coated with the predefined luminescence material. Alternatively, the object may intrinsically comprise the predefined luminescence material by nature.

The proposed system may further comprise an output unit which is configured to output at least the identified object and the calculated distance, shape, depth and/or surface information of the identified object. The output unit may be a display unit which is configured to display at least the identified object and the calculated distance, shape, depth and/or surface information of the identified object. Alternatively, the output unit is an acoustic output unit, such as a loudspeaker or a combination of display and loudspeaker. The output unit is in communicative connection with the data processing unit.

Some or all technical components of the proposed system, namely the light source, the sensor, the data processing unit, the data storage unit, the control unit and/or the output unit may be in communicative connection with each other. A communicative connection between any of the components may be a wired or a wireless connection. Each suitable communication technology may be used. The respective components, each may include one or more communications interface for communicating with each other. Such communication may be executed using a wired data transmission protocol, such as fiber distributed data interface (FDDI), digital subscriber line (DSL), Ethernet, asynchronous transfer mode (ATM), or any other wired transmission protocol. Alternatively, the communication may be wirelessly via wireless communication networks using any of a variety of protocols, such as General Packet Radio Service (GPRS), Universal Mobile Telecommunications System (UMTS), Code Division Multiple Access (CDMA), Long Term Evolution (LTE), wireless Universal Serial Bus (USB), and/or any other wireless protocol. The respective communication may be a combination of a wireless and a wired communication.

The present disclosure also refers to a method for object recognition via a computer vision application, the method comprising at least the following steps:
providing an object with object specific reflectance and luminescence spectral patterns, the object is to be recognized,
projecting at least one light pattern on a scene which includes the object to be recognized,
measuring, by means of a sensor, radiance data of the scene including the object when the scene is illuminated by the light source,
providing a data storage unit which comprises luminescence spectral patterns together with appropriately assigned respective objects,
providing a data processing unit which is programmed to
   detect/extract the object specific luminescence spectral pattern of the object to be recognized out of the radiance data of the scene and to match the detected/extracted object specific luminescence spectral pattern with the luminescence spectral patterns stored in the data storage unit, and to identify a best matching luminescence spectral pattern and, thus, its assigned object, and to
   calculate a distance, a shape, a depth and/or surface information of the identified object in the scene by reflectance characteristics measured by the sensor.

The reflectance characteristics may include temporal elements, such as the amount of time it takes for light (forming part of the object specific reflectance pattern) to return to the sensor, or spatial measurements, such as the measured distortion of the emitted spatial light pattern, i.e. by the way the light pattern deforms when striking a surface of the object.

In one aspect, the step of providing an object to be recognized comprises imparting/providing the object with a luminescence material, thus providing the object with object specific reflectance and luminescence spectral patterns.

Thus, the object to be recognized, is provided/imparted, e. g. coated, with predefined surface luminescent materials (particularly luminescent dyes) whose luminescent chemistry, i.e. luminescence spectral pattern, is known and used as a tag. By using luminescent chemistry of the object as a tag, object recognition is possible irrespective of the shape of the object or partial occlusions.

The object can be imparted, i. e. provided with luminescent, particularly fluorescent materials in a variety of methods. Fluorescent materials may be dispersed in a coating that may be applied through methods such as spray coating, dip coating, coil coating, roll-to-roll coating, and others. The fluorescent material may be printed onto the object. The fluorescent material may be dispersed into the object and extruded, molded, or cast. Some materials and objects are naturally fluorescent and may be recognized with the proposed system and/or method. Some biological materials (vegetables, fruits, bacteria, tissue, proteins, etc.) may be genetically engineered to be fluorescent. Some objects may be made fluorescent by the addition of fluorescent proteins in any of the ways mentioned herein.

A vast array of fluorescent materials is commercially available. Theoretically, any fluorescent material should be suitable for the computer vision application, as the fluorescent spectral pattern of the object to be identified is measured after production. The main limitations are durability of the fluorescent materials and compatibility with the host material (of the object to be recognized). Optical brighteners are a class of fluorescent materials that are often included in object formulations to reduce the yellow color of many organic polymers. They function by fluorescing invisible ultraviolet light into visible blue light, thus making the produced object appear whiter. Many optical brighteners are commercially available. The step of imparting fluorescence to the object may be realized by coating the object with the fluorescence material or otherwise imparting fluorescence to the surface of the object. In the latter case fluorescence may be distributed throughout the whole object, and may thus be detectable at the surface as well.

The technique for providing the object to be recognized with a luminescence material can be chosen as one or a combination of the following techniques: spraying, rolling, drawing down, deposition (PVC, CVD, etc.), extrusion, film application/adhesion, glass formation, molding techniques, printing such as inks, all types of gravure, inkjet, additive manufacturing, fabric/textile treatments (dye or printing processes), dye/pigment absorption, drawings (hand/other), imparting stickers, imparting labels, imparting tags, chemical surface grafting, dry imparting, wet imparting, providing mixtures into solids, providing reactive/nonreactive dyes.

In a further aspect, the method additionally comprises the step of outputting via an output device at least the identified object and the calculated distance, shape, depth and/or surface information of the identified object. The output device can be realized by a display device which is coupled (in communicative connection) with the data processing unit. The output device may also be an acoustic output device, such as a loudspeaker or a visual and acoustic output device.

According to still a further embodiment of the proposed method, the matching step comprises to identify the best matching specific luminescence spectral pattern by using any number of matching algorithms between the estimated object specific luminescence spectral pattern and the stored luminescence spectral patterns. The matching algorithms may be chosen from the group comprising at least one of: lowest root mean squared error, lowest mean absolute error, highest coefficient of determination, matching of maximum wavelength value. Generally, the matching algorithms are arbitrary.

In still another aspect, the extracting step comprises to estimate, using the measured radiance data, the luminescence spectral pattern and the reflective spectral pattern of the object in a multistep optimization process.

The data processing unit may include or may be in communication with one or more input units, such as a touch screen, an audio input, a movement input, a mouse, a keypad input and/or the like. Further the data processing unit may include or may be in communication with one or more output units, such as an audio output, a video output, screen/display output, and/or the like.

Embodiments of the invention may be used with or incorporated in a computer system that may be a standalone unit or include one or more remote terminals or devices in communication with a central computer, located, for example, in a cloud, via a network such as, for example, the Internet or an intranet. As such, the data processing unit described herein and related components may be a portion of a local computer system or a remote computer or an online system or a combination thereof. The database, i.e. the data storage unit and software described herein may be stored in computer internal memory or in a non-transistory computer readable medium.

The present disclosure further refers to a computer program product having instructions that are executable by a computer, the instructions cause a machine to:
provide an object with object specific reflectance and luminescence spectral patterns, the object is to be recognized,
project at least one light pattern on a scene which includes the object to be recognized,
measure by means of a sensor radiance data of the scene including the object when the scene is illuminated by the light source,
provide a data storage unit which comprises luminescence spectral patterns together with appropriately assigned respective objects,
extract the object specific luminescence spectral pattern of the object to be recognized out of the radiance data of the scene,
match the extracted object specific luminescence spectral pattern with the luminescence spectral patterns stored in the data storage unit,
identify a best matching luminescence spectral pattern and, thus, its assigned object, and
calculate a distance, a shape, a depth and/or surface information of the identified object in the scene by reflectance characteristics measured by the sensor.

The reflectance characteristics may include temporal elements, such as the amount of time it takes for reflected light to return to the sensor, or spatial measurements, such as the measured distortion of the emitted spatial light pattern, i.e. by the way the light pattern deforms when striking a surface of the object.

The present disclosure further refers to a non-transitory computer-readable medium storing instructions that, when executed by one or more processors, cause a machine to:
provide an object with object specific reflectance and luminescence spectral patterns, the object is to be recognized,
project, by a light source, at least one light pattern on a scene which includes the object to be recognized,
measure, by means of a sensor, radiance data of the scene including the object when the scene is illuminated by the light source,
provide a data storage unit which comprises luminescence spectral patterns together with appropriately assigned respective objects,
extract the object specific luminescence spectral pattern of the object to be recognized out of the radiance data of the scene,
match the extracted object specific luminescence spectral pattern with the luminescence spectral patterns stored in the data storage unit,
identify a best matching luminescence spectral pattern and, thus, its assigned object, and
calculate a distance, a shape, a depth and/or surface information of the identified object in the scene by reflectance characteristics measured by the sensor.

The invention is further defined in the following examples. It should be understood that these examples, by indicating preferred embodiments of the invention, are given by way of illustration only. From the above discussion and the examples, one skilled in the art can ascertain the essential characteristics of this invention and without departing from the spirit and scope thereof, can make various changes and modifications of the invention to adapt it to various uses and conditions.

### BRIEF DESCRIPTION OF THE DRAWINGS

FIGS. 1a and 1b show schematically embodiments of the proposed system.

### DETAILED DESCRIPTION OF THE DRAWINGS

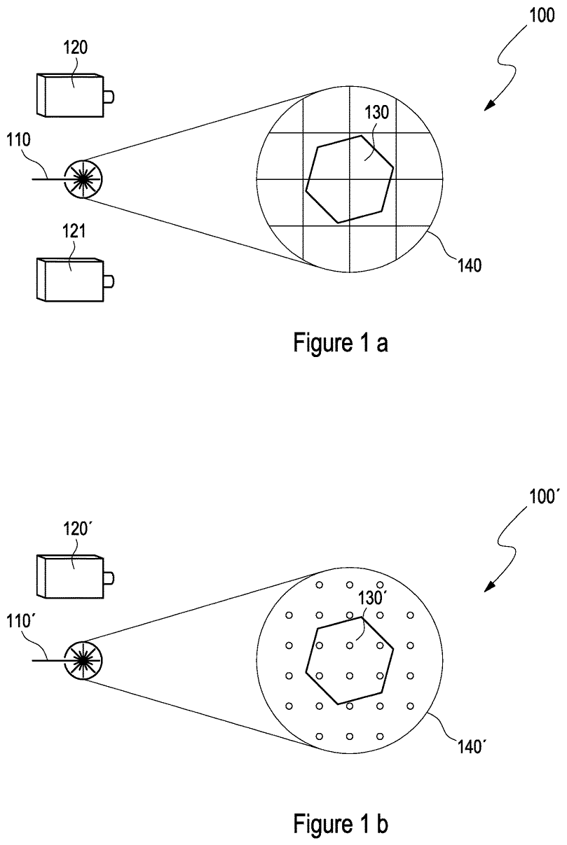

FIG. 1a and FIG. 1b show schematically embodiments of the proposed system. In FIG. 1a the system 100 includes at least one object 130 to be recognized. Further, the system includes two sensors 120 and 121 which can be realized by an imager, such as a camera, particularly a multispectral or hyperspectral camera, respectively. The system 100 further includes a light source 110. The light source 110 is composed of different individual illuminants, the number of which and nature thereof depend on the method used. The light source 110 may be composed of two illuminants or of three illuminants, for example, that are commonly available. The two illuminants could be chosen as custom LED illuminants. Three illuminants can be commonly available incandescent, compact fluorescent and white light LED bulbs.

The light source 110 in FIG. 1a is configured to project a light pattern on a scene 140 which includes the object 130 to be recognized. The light pattern projected by the light source 110 on the scene 140 is chosen here as a spatial light pattern, namely as a grid. That means that only some points within the scene 140 and, thus, only some points of the object 130 to be recognized are hit by the light emitted by the light source 110.

The sensors shown in FIG. 1a are both configured to measure radiance data of the scene 140 including the object 130 when the scene 140 is illuminated by the light source 110. It is possible to choose different sensors, namely one sensor which is configured to only measure light of the same wavelength as the emitted structured light. Thus, the effect of ambient lighting condition is minimized and the sensor can clearly measure a deviation from the known geometry of the light introduced to the scene 140 upon the return of the light reflected back to the sensor 120, 121 so that a data processing unit which is not shown here can use such distortions to calculate a distance, a shape, a depth and/or other object information of the object 130 to be recognized. Wavelength of light used by this sensor 120, 121 can be anywhere in UV, visible or near-IR regions of the whole light spectrum. The second sensor 120, 121 may be a multispectral or hyperspectral camera which is configured to measure radiance data of the scene 140 including the object 130 over the entire light spectrum, or over at least that part of the light spectrum that comprises the fluorescence spectral pattern of the object 130. Thus, the second sensor 120, 121 is also configured to measure radiance data of the scene 140 including the object 130 resulting not only from the reflective but also the fluorescent response of the object 130. The data processing unit is configured to extract the object-specific luminescence spectral pattern of the object 130 to be recognized out of the radiance data of the scene 140 and to match the extracted object-specific luminescence spectral pattern with luminescence spectral patterns stored in a data storage unit (not shown here) and to identify a best matching luminescence spectral pattern and, thus, its assigned object. Further, as already mentioned above, the data processing unit is configured to calculate a distance, a shape, a depth and/or surface information of the identified object 130 in the scene 140 by the way the reflected light pattern deforms when striking a surface of the object 130. The system 100 shown here uses on the one side structured light to calculate things such as distance to the object 130 or object shape by means of the reflective answer of the object 130 when being hit by the light emitted from the light source 110. On the other hand, the proposed system 100 uses the separation of fluorescent emission and reflective components of the object 130 to be recognized to identify the object 130 by its spectral signature, namely by its specific fluorescence spectral pattern. Thus, the proposed system 100 combines both methods, namely the method of identifying the object 130 by its object-specific fluorescence pattern and, in addition, the method of identifying its distance, shape and other properties with the reflected portion of the light spectrum due to the distortion of the structured light pattern. The data processing unit and the data storage unit are also components of the system 100.

FIG. 1b shows an alternative embodiment of the proposed system. The system 100′ comprises a light source 110′ which is configured to emit UV, visible or infrared light in a known pattern, such as a dot matrix as indicated in FIG. 1b. Generally, it is possible that the light source 110′ is configured to either emit pulses of light into the scene 140′, thus, generating a temporal light pattern, to partially emit light into the scene 140′, generating a spatial light pattern or to emit a combination of the two. A combination of pulsed and spatially structured light can be emitted for example by a dot matrix projector, a LiDAR, etc. The system 100′ shown in figure lb further comprises a sensor 120′ which is configured to sense/record radiance data/responses over the scene 140′ at different wavelength ranges. That means that not only a merely reflective response of the scene 140′ including the object 130′ to be recognized is recorded but also a fluorescent response of the object 130′. The system 100′ further comprises a data processing unit and a data storage unit. The data storage unit comprises a database of fluorescence spectral patterns of a plurality of different objects. The data processing unit is in communicative connection with the data storage unit and also with the sensor 120′. Therefore, the data processing unit can calculate the luminescence emission spectrum of the object 130′ to be recognized and search the database of the data storage unit for a match with the calculated luminescence emission spectrum. Thus, the object 130′ to be recognized can be identified if a match within the database can be found. Additionally, it is possible by using the structured light which has been emitted from the light source 110′ and projected on the scene 140′ and, thus, also on the object 130′ to be recognized, to derive from a measured distortion of the light pattern reflected back to the sensor 120′ further information about the object 130′ to be recognized such as distance, shape, surface information of the object 130′. That means that by choosing a light source 110′ generally used for 3D mapping tools to accommodate luminescence responses from the object to be recognized and utilizing a sensor 120′ with specific spectral reading bands, the proposed system 100′ is able to calculate not only a best matching spectral luminescent material but also a distance to the object 130′ or an object shape and other 3D information about the object 130′. The proposed system enables the use of luminescent color-based object recognition system and 3D space mapping tools simultaneously. That means that the proposed system 100′ allows identifying the object 130′ by its spectral signature such as its object-specific luminescence spectrum in addition to calculate its distance/shape/other properties with the reflected portion of the light which has been projected into the scene 140′.

Further, it is to be stated that it is possible that the light source emits a plurality of different light patterns one after the other or to emit a plurality of different light patterns simultaneously. By the usage of different light patterns it is possible to derive from the respective different reflected responses of the scene, and the object within the scene detailed information about the shape, depth and distance of the object. Each of the plurality of light patterns which is projected into the scene hits the object at different sections/areas of its surface and, therefore, each pattern provides different information which can be derived from the respective reflective response. The data processing unit which is in communicative connection with the sensor which records all those reflective responses can merge all the different reflective responses assigned to the different light patterns and can calculate therefrom a detailed 3D structure of the object to be recognized. Summarized, the proposed system can identify the object due to a measurement of the object-specific luminescence spectral pattern and provide detailed information about the distance of the object to the sensor and, further, 3D information of the object due to distortion of the light pattern reflected back to the sensor. Not only different light patterns can be projected onto the object in order to hit all surface sections of the object but also different patterns of light at different wavelength ranges can be projected onto the object, thus providing further information about the reflective and also fluorescent nature of the surface of the object.

### LIST OF REFERENCE SIGNS

100, 100′ system

110, 110′ light source

120, 121, 120′ sensor

130, 130′ object to be recognized

140, 140′ scene

1. A system for object recognition via a computer vision application, the system comprising at least the following components:
an object to be recognized, the object having object specific reflectance and luminescence spectral patterns,
a light source which is configured to project at least one light pattern on a scene which includes the object to be recognized,
a sensor which is configured to measure radiance data of the scene including the object when the scene is illuminated by the light source,
a data storage unit which comprises luminescence spectral patterns together with appropriately assigned respective objects, and
a data processing unit which is configured to
detect the object specific luminescence spectral pattern of the object to be recognized out of the radiance data of the scene and to match the detected object specific luminescence spectral pattern with the luminescence spectral patterns stored in the data storage unit, and to identify a best matching luminescence spectral pattern and, thus, its assigned object, and
calculate a distance, a shape, a depth and/or surface information of the identified object in the scene by reflectance characteristics measured by the sensor.

2. The system according to claim 1, wherein the at least one light pattern is a temporal light pattern, a spatial light pattern or a temporal and spatial light pattern.

3. The system according to claim 2, wherein in the case that the light source is configured to project a spatial light pattern or a temporal and spatial light pattern on the scene, the spatial part of the light pattern is formed as a grid, an arrangement of horizontal, vertical, and/or diagonal bars, an array of dots or a combination thereof.

4. The system according to claim 2, wherein in the case that the light source is configured to project a temporal light pattern or a temporal and spatial light pattern on the scene, the light source comprises a pulsed light source which is configured to emit light in single pulses thus providing the temporal part of the light pattern.

5. The system according to claim 2, wherein the light source is selected from the group consisting of a dot matrix projector and a time of flight sensor.

6. The system according to claim 1, wherein the sensor is a hyperspectral camera or a multispectral camera.

7. The system according to claim 1, wherein the light source is configured to emit one or more spectral bands within UV, visible and/or infrared light simultaneously or at different times in the at least one light pattern.

8. The system according to claim 1, wherein the object to be recognized is provided with a predefined luminescence material and the resulting object's luminescence spectral pattern is known and used as a tag.

9. The system according to claim 1, further comprising a display unit which is configured to display at least the identified object and the calculated distance, shape, depth and/or surface information of the identified object.

10. A method for object recognition via a computer vision application, the method comprising at least the following steps:
providing an object with object specific reflectance and luminescence spectral patterns, the object is to be recognized,
projecting by means of a light source, at least one light pattern on a scene which includes the object to be recognized,
measuring, by means of a sensor, radiance data of the scene including the object when the scene is illuminated by the light source,
providing a data storage unit which comprises luminescence spectral patterns together with appropriately assigned respective objects, and
providing a data processing unit which is programmed to
detect the object specific luminescence spectral pattern of the object to be recognized out of the radiance data of the scene and to match the detected object specific luminescence spectral pattern with the luminescence spectral patterns stored in the data storage unit, and to identify a best matching luminescence spectral pattern and, thus, its assigned object, and to
calculate a distance, a shape, a depth and/or surface information of the identified object in the scene by reflectance characteristics measured by the sensor.

11. The method according to claim 10, wherein the step of providing an object to be recognized comprises providing the object with a luminescence material, thus providing the object with an object specific luminescence spectral pattern.

12. The method according to claim 10, further comprising the step of displaying via a display device at least the identified object and the calculated distance, shape, depth and/or surface information of the identified object.

13. The method according to claim 10, wherein the matching step comprises identifying the best matching specific luminescence spectral pattern by using any number of matching algorithms between the estimated object specific luminescence spectral pattern and the stored luminescence spectral pattern.

14. The method according to claim 10, wherein the detecting step comprises estimating, using the measured radiance data, the luminescence spectral pattern and the reflective spectral pattern of the object in a multistep optimization process.

15. A non-transitory computer-readable medium storing instructions that, when executed by one or more processors, cause a machine to:
provide an object with object specific reflectance and luminescence spectral patterns, the object is to be recognized,
project, by a light source, at least one light pattern on a scene which includes the object to be recognized,
measure, by means of a sensor, radiance data of the scene including the object when the scene is illuminated by the light source,
provide a data storage unit which comprises luminescence spectral patterns together with appropriately assigned respective objects,
extract the object specific luminescence spectral pattern of the object to be recognized out of the radiance data of the scene,
match the extracted object specific luminescence spectral pattern with the luminescence spectral patterns stored in the data storage unit,
identify a best matching luminescence spectral pattern and, thus, its assigned object, and
calculate a distance, a shape, a depth and/or surface information of the identified object in the scene by reflectance characteristics measured by the sensor.
